(19) United States
(12) Patent Application Publication
(10) Pub. No.: US 2014/0076821 A1
(43) Pub. Date: Mar. 20, 2014

(54) Process for Recovering Organics From Wastewater

(71) Applicant: KiOR, Inc., Pasadena, TX (US)

(72) Inventor: Ronny W. Lin, Sugar Land, TX (US)

(73) Assignee: KiOR, Inc., Pasadena, TX (US)

(21) Appl. No.: 13/975,092

(22) Filed: Aug. 23, 2013

Related U.S. Application Data
(60) Provisional application No. 61/703,408, filed on Sep. 20, 2012.

(51) Int. Cl. C02F 1/52

(52) U.S. Cl. CPC C02F 1/5236
USPC 210/702

(57) ABSTRACT

Disclosed is a method for treating wastewater by removing organics, such as water-soluble organics, by catalysis in the presence of an acid. Removal of such organics is in the form of a tar which includes phenol-derived compounds.

### CROSS REFERENCE TO RELATED APPLICATIONS/INCORPORATION BY REFERENCE STATEMENT

This application is a non-provisional application claiming the benefit of co-pending U.S. Provisional Application No. 61/703,408, filed Sep. 20, 2012, which is hereby incorporated by reference in its entirety herein.

### FIELD OF THE INVENTION

The invention relates generally to a method for removing organics from a wastewater stream. More specifically, the invention relates to the removal of organics, including water-soluble organics, from a wastewater stream by catalysis in the presence of an acid.

### BACKGROUND OF THE INVENTION

With the rising costs and environmental concerns associated with fossil fuels, renewable energy sources have become increasingly important, and in particular, the production of renewable transportation fuels from the conversion of biomass feedstocks. Many different processes have been, and are being, explored for the conversion of biomass to biofuels and/or specialty chemicals. Some of the existing biomass conversion processes include, for example, combustion, gasification, liquefaction, enzymatic conversion, and thermo-catalytic or pyrolytic conversion. Each of these processes, in particular pyrolytic or thermo-catalytic conversion of biomass, can form a wastewater stream containing organics compounds including water-soluble organics. In particular, such water-soluble organics can include phenol compounds. Some past methods have focused on separating and recovering certain of the organics through fractionation. These methods suffer from the high costs of purifying such target organics in order to achieve sufficient market value. Other methods have intended to use such organics as a source of hydrogen from reforming reactions. These methods can be quite expensive to implement, and the cost of purifying the resulting hydrogen to a useful concentration can also be high.

Accordingly, there remains a need for an improved and efficient method for removing organics, including water-soluble organics, from a wastewater stream.

### SUMMARY OF THE INVENTION

In accordance with an embodiment of the invention, a method for treating wastewater is provided and comprises:

(a) adding an acid having a pKa value less than or equal to −1 to the wastewater which comprises water-soluble organics, wherein the water-soluble organics comprise phenols which are present in the wastewater in an amount of at least about 1 wt %, and wherein the acid catalyzes the reaction of at least a portion of the water-soluble organics to form water-insoluble organics which settle out of the wastewater thereby forming a tar and treated water which comprises less water-soluble organics than the wastewater; and

(b) separating at least a portion of the tar from the treated water.

In accordance with another embodiment of the invention, the water-soluble organics further comprise oxygenated compounds selected from the group consisting of ketones, aldehydes, carboxylic acids, alcohols, ethers, esters, and combinations thereof.

In accordance with other embodiments of the invention, the tar contains at least about 25 wt % of phenol-derived compounds.

### BRIEF DESCRIPTION OF THE DRAWINGS

FIG. 1 is a picture of test tubes containing samples of untreated and sulfuric acid treated wastewater produced from the thermo-catalytic conversion of southern yellow pine wood chips, and shows tar formation after 2.5 days of settling.

FIG. 2 is a picture of test tubes containing samples of sulfuric acid treated wastewater produced from the thermo-catalytic conversion of southern yellow pine wood chips, and shows tar formation at different sulfuric acid concentrations after 20 hours of settling.

FIG. 3 is a picture of test tubes containing samples of sulfuric acid treated wastewater produced from the thermo-catalytic conversion of southern yellow pine wood chips, and shows tar formation at different sulfuric acid concentrations after 48 hours of settling.

### DETAILED DESCRIPTION OF THE INVENTION

The wastewater can be from any source wherein water-soluble organics are present in the wastewater. Such source can be, for example, from biomass conversion using combustion, gasification, liquefaction, enzymatic conversion, and thermo-catalytic or pyrolytic conversion. The biomass material useful in producing bio-oils, and the resulting wastewater, can be any biomass capable of being converted to liquid and gaseous hydrocarbons.

Preferred are solid biomass materials comprising a cellulosic material, in particular lignocellulosic materials, because of the abundant availability of such materials, and their low cost. The solid biomass feed can comprise components selected from the group consisting of lignin, cellulose, hemicelluloses, and combinations thereof. Examples of suitable solid biomass materials include forestry wastes, such as wood chips and saw dust; agricultural waste, such as straw, corn stover, sugar cane bagasse; municipal waste, in particular yard waste, paper, and card board; energy crops such as switch grass, coppice, eucalyptus; and aquatic materials such as algae; and the like.

The biomass can be converted at elevated temperatures to form a conversion reactor effluent. In particular, the biomass can be converted in a conversion reactor containing a heat carrier material to thereby produce the conversion reactor effluent comprising vapor conversion products and heat carrier material. The conversion reactor effluent can also include under-reacted biomass, coke, or char. The vapor conversion products comprise, consist of, or consist essentially of non-condensable gases including CO and CO₂, bio-oil, and water. The conversion reactor can be operated at a temperature in the range of from about 200° C. to about 1000° C., or between about 250° C. and about 800° C., and can be operated in the substantial absence of oxygen. Also, at least a portion of the heat carrier can be a catalyst.

Such catalyst can be any catalyst capable of converting biomass to a bio-oil product having relatively low oxygen levels. The oxygen levels of such bio-oil can be less than about 20 wt % on a dry basis.

More particularly, useful catalysts for the current invention include those containing catalytic acidity and can contain a zeolite. Examples of suitable zeolites include ZSM-5, ZSM-11, ZSM-22, ZSM-23, ZSM-48, mordenite, beta, ferrierite, and zeolite-Y. Additionally, the catalyst may comprise a super acid, including sulfonated, phosphated, or fluorinated forms of zirconia, titania, alumina, silica-alumina, or clays, pillared layered clays and/or silicotitanates or pillared layered silicotitanates. In another embodiment, the catalyst may comprise a solid base including metal oxides, metal hydroxides, and/or metal carbonates. In particular, the oxides, hydroxides, and carbonates of alkali metals, alkaline earth metals, transition metals, and/or rare earth metals are suitable. Other suitable solid bases are layered double hydroxides, mixed metal oxides, hydrotalcite, clays, and/or combinations thereof. In yet another embodiment, the catalyst can also comprise an alumina, such as alpha-alumina.

At least a portion of the vapor conversion products, from either or both of a catalytic or non-catalytic conversion process as described above, can be separated from the conversion reactor effluent, and at least a portion of the vapor conversion products thus separated can be condensed to form a condensate comprising bio-oil and wastewater.

When the heat carrier does not include a catalyst component, the condensate can first be at least partially upgraded, such as by deoxygenation, which can include hydrotreatment, in order to make the resulting upgraded condensate more susceptible to separation. At least a portion of the bio-oil can then be separated from the upgraded condensate, also forming a wastewater.

When the heat carrier includes the catalyst as described above, at least a portion of the bio-oil can be separated from the condensate, without the necessity of prior upgrading, also forming a wastewater.

In either case, such separation can be by any method capable of separating bio-oil from the wastewater, and can include, but is not limited to, centrifugation, gravity separation, and the like. In a specific embodiment, the condensate is separated by gravity separation in a settling vessel into the bio-oil and into the wastewater.

The bio-oil can then be upgraded to lower oxygen levels forming an upgraded bio-oil. Such upgrading can be by at least partially deoxygenating and/or hydrotreating the bio-oil.

The wastewater, from whatever source, can comprise water-soluble organics, and such water-soluble organics can comprise phenols which can be present in the wastewater in an amount of at least about 1 wt %. The water-soluble organics can further comprise oxygenated compounds selected from the group consisting of ketones, aldehydes, carboxylic acids, alcohols, ethers, esters, and combinations thereof.

In accordance with an embodiment of the invention, the wastewater can be treated by a method comprising, consisting of, or consisting essentially of adding an acid having a pKa value less than or equal to −1, or less than or equal to −1.2, to the wastewater, wherein the acid can catalyze the reaction of at least a portion of the water-soluble organics to form water-insoluble organics. The water-insoluble organics can settle out of the wastewater thereby forming a tar and treated water which comprises less water-soluble organics than the wastewater. At least a portion of the tar can then be separated from the treated water. After the addition of the acid to the wastewater, the wastewater can be at a temperature of at least about 50° C. or at least about 60° C. and can also be less than about 200° C.

The wastewater can comprise at least about 4 wt % or at least about 5 wt % water-soluble organics and the treated water can comprise less than about 80 wt % or less than about 75 wt % of the water-soluble organics contained in the wastewater.

The tar can contain at least about 25 wt % or at least about 40 wt % of phenol-derived compounds. Also, at least about 20% or at least about 30% of the phenols contained in the wastewater can become a part of the tar.

In accordance with an embodiment of the invention, prior to the addition of the acid to the wastewater, the wastewater has a pH value in the range of about 2 to about 3. The acid can be added to the wastewater in an amount such that the concentration of the acid in the wastewater is at least about 300 ppmw or at least about 500 ppmw or at least about 1000 ppmw, based on the total weight of the wastewater. In accordance with an embodiment of the invention, the acid can be added to the wastewater in an amount such that the concentration of the acid in the wastewater is no more than about 2 wt %, based on the total weight of the wastewater. The acid can be selected from the group consisting of sulfuric acid, hydrochloric acid, hydrobromic acid, phosphoric acid, and combinations thereof. In accordance with an embodiment of the invention, the acid is sulfuric acid.

After no more than about 1 day following the addition of the acid to the wastewater the wt % of tar is greater than about 2 wt %, based on the combined weight of the treated water and the tar. Also, after no more than about 4 days following the addition of the acid to the wastewater the wt % of tar is greater than about 3 wt %, based on the combined weight of the treated water and the tar. Further, after no more than about 20 days following the addition of the acid to the wastewater the wt % of tar is greater than about 4 wt %, based on the combined weight of the treated water and the tar.

The recovered tar can be combined with the produced bio-oil to thus increase bio-oil yield. The combined bio-oil can then be further processed into bio-fuels or chemicals. The tar can also be further processed separately from the produced bio-oil to form bio-fuels, asphalt-range materials, or chemicals.

### EXAMPLES

For each of the following examples, southern yellow pine wood chips were subjected to thermo-catalytic conversion to produce reaction products which were condensed and gravity separated into bio-oil and wastewater streams.

### Example 1

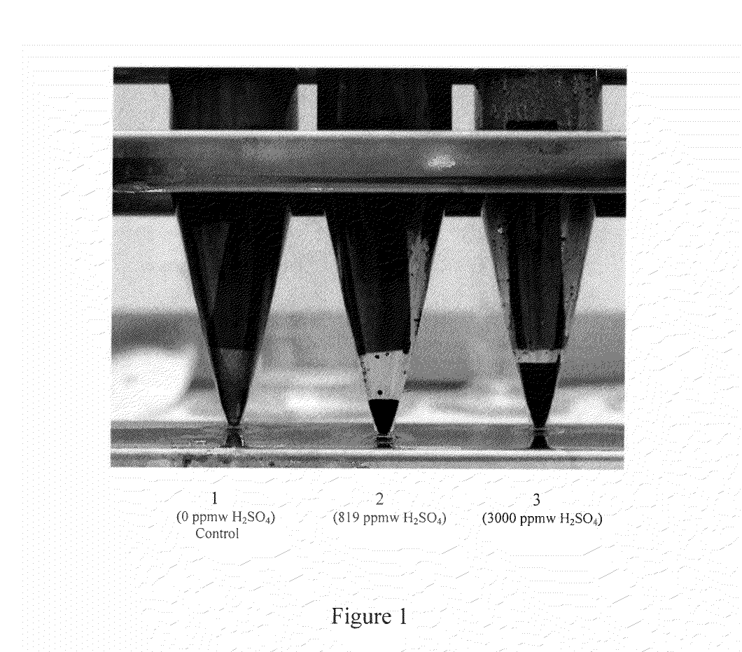

Three samples of a wastewater were used in this Example 1. Sample 1 was used as a control, including 0 ppmw sulfuric acid. Sulfuric acid was added to Samples 2 and 3 in amounts such that the resulting sulfuric acid concentrations were 819 ppmw and 3000 ppmw, respectively. The temperature of each of the Samples 1-3 following addition, if any, of the sulfuric acid was about 60° C. FIG. 1 is a picture of the Samples after 2.5 days of settling, and shows that there was very little tar formation in Sample 1 (no sulfuric acid addition), whereas Samples 2 and 3 demonstrated that tar formation increased with increasing amounts of added sulfuric acid.

### Example 2

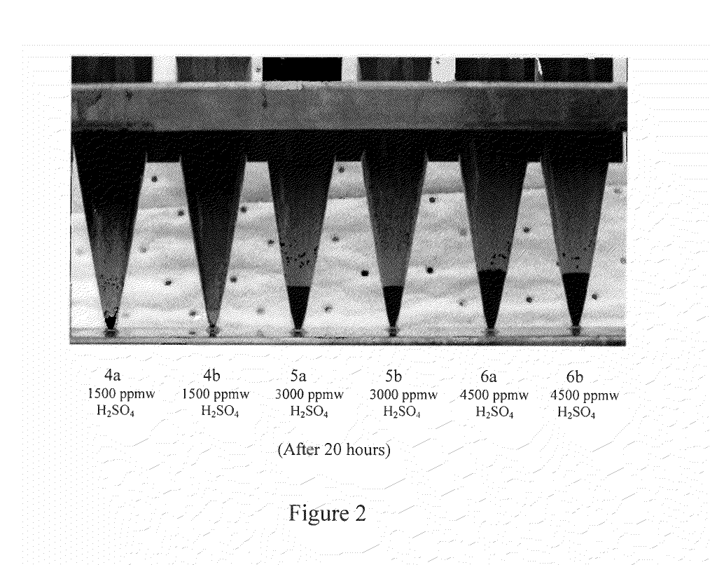

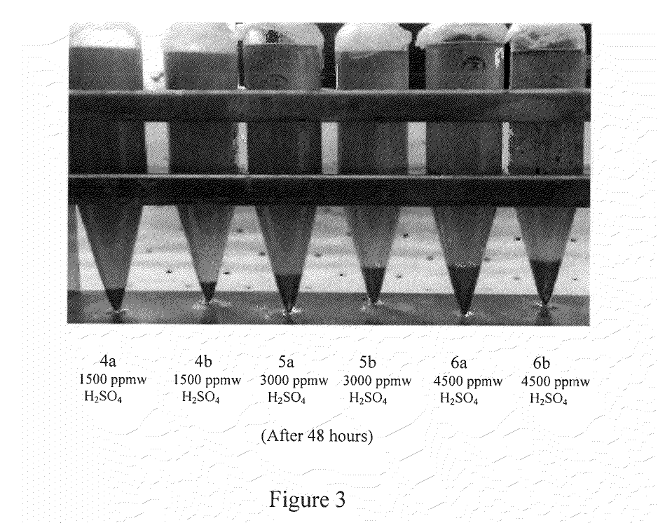

Six samples of another wastewater were used in this Example 2 (Samples 4a, 4b, 5a, 5b, 6a, and 6b). Sulfuric acid was added to Samples 4a and 4b in amounts such that the resulting sulfuric acid concentration was 1500 ppmw. Sulfuric acid was added to Samples 5a and 5b in amounts such that the resulting sulfuric acid concentration was 3000 ppmw. Sulfuric acid was added to Samples 6a and 6b in amounts such that the resulting sulfuric acid concentration was 4500 ppmw. The temperature of each of the Samples 4a-6b following addition of the sulfuric acid was about 60 ° C. FIG. 2 is a picture of the Samples after 20 hours of settling, and shows that there was little tar formation in Samples 4a and 4b, whereas Samples 5a and 5b demonstrated substantially increased tar formation at 3000 ppmw. Samples 6a and 6b show even more tar formation when the wastewater contains 4500 ppmw sulfuric acid. FIG. 3 is a picture of the Samples after 48 hours of settling, and also shows that tar formation increased with increasing amounts of added sulfuric acid.

### Example 3

Sample 7 was the starting wastewater used in the testing of a Sample 8, but with 0 ppmw sulfuric acid ad ded. Sulfuric acid was added to Sample 8 of such wastewater in an amount such that the resulting sulfuric acid concentration was 1 wt %. The temperature of Sample 8 following addition of the sulfuric acid was about 60 ° C. The amount of tar formed in the treated wastewater of Sample 8 was measured at 0.7 day, 3.5 days and 21 days, and the results are shown in Table 1 below. The starting wastewater of Sample 7 and the treated wastewater of Sample 8 (at 3.5 and 21 days) were analyzed by GC/MS and the area percents of such testing are also shown in Table 1 below.

TABLE 1

| | Sample 7 | Sample 8 | | |
|---|---|---|---|---|
| Days of Treatment | 0 | 0.7 | 3.5 | 21 |
| Accumulated Tar (g) | 0 | 1.79 | 2.93 | 3.98 |
| Wt % Tar in Wastewater | 0 | 2.23 | 3.66 | 4.96 |
| GC/MS (area %) | | | | |
| Formadehyde | 5.230 | Not analyzed | 4.635 | 2.200 |
| Acetaldehyde | 1.705 | Not analyzed | 0.750 | 0.170 |
| 2,2-Bifuran | 0.005 | Not analyzed | ND | ND |
| 2-Cyclopenten-1-one | 0.155 | Not analyzed | 0.030 | ND |
| Methacrolein | 0.005 | Not analyzed | 0.005 | ND |
| 2-Butanone | 0.145 | Not analyzed | 0.025 | ND |
| 3-Buten-2-one | 0.255 | Not analyzed | 0.085 | 0.040 |
| Furfural | 0.015 | Not analyzed | ND | ND |
| 2-Pentanone | 0.015 | Not analyzed | ND | ND |
| 3-Pentanone | 0.005 | Not analyzed | ND | ND |
| 2,3-Pentandione | 0.010 | Not analyzed | 0.010 | 0.005 |
| 2,5-Dihydrotoluene | 0.005 | Not analyzed | ND | ND |
| Acetic acid | 3.470 | Not analyzed | 3.510 | 2.375 |
| 3-Pennten-2-one | 0.005 | Not analyzed | ND | ND |
| Cyclopentanone | 0.020 | Not analyzed | ND | ND |
| Propanoic acid | 0.405 | Not analyzed | 0.390 | 0.275 |
| 1-Hydroxy-2-propanone | 1.025 | Not analyzed | 0.450 | ND |
| 2-Methyl-2-cyclopentanone | 0.015 | Not analyzed | 0.010 | ND |
| Phenol | 0.205 | Not analyzed | ND | ND |
| 2-Methylphenol | 0.050 | Not analyzed | ND | ND |
| 1-H-Indenol | 0.005 | Not analyzed | ND | ND |
| 1-Penten-3-one | 0.005 | Not analyzed | ND | ND |
| (p + m) Cresol | 0.095 | Not analyzed | ND | ND |
| Phenol, 2,5-dimethyl- | 0.015 | Not analyzed | ND | ND |
| Phenol, 4-ethyl | 0.015 | Not analyzed | ND | ND |
| Phenol, 3,4-dimethyl- | 0.005 | Not analyzed | ND | ND |
| 3-Methyl-1,2-benzenediol | 0.070 | Not analyzed | ND | ND |
| 1,2-Benzenediol | 0.675 | Not analyzed | ND | ND |
| 4-Methyl-1,2-benzenediol | 0.145 | Not analyzed | ND | ND |
| 1,4-Benzenediol | 0.100 | Not analyzed | ND | ND |
| 2-Ethyl-5-methylphenol | 0.005 | Not analyzed | ND | ND |

ND—Non-detectable;
detection limit of 0.005 area %

As can be seen from Table 1 above, treatment of the wastewater of Sample 8 with sulfuric acid resulted in significant decreases in organic compounds, and especially the phenol compounds. Also, the wt % tar continued to increase with increasing treatment time, which appears to indicate acid catalyzed formation of the tar as opposed to just acidification of the water-soluble organics with the acid.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, unless expressly stated otherwise, the term “about” as used herein is intended to include and take into account variations due to manufacturing tolerances and/or variabilities in process control.

Changes may be made in the construction and the operation of the various components, elements and assemblies described herein, and changes may be made in the steps or sequence of steps of the methods described herein without departing from the spirit and the scope of the invention as defined in the following claims.

What is claimed is:

1. A method for treating wastewater comprising:
(a) adding an acid having a pKa value less than or equal to −1 to said wastewater which comprises water-soluble organics, wherein said water-soluble organics comprise phenols which are present in said wastewater in an amount of at least about 1 wt %, and wherein said acid catalyzes the reaction of at least a portion of said water-soluble organics to form water-insoluble organics which settle out of said wastewater thereby forming a tar and treated water which comprises less water-soluble organics than said wastewater; and
(b) separating at least a portion of said tar from said treated water.

2. The method of claim 1 wherein said water-soluble organics further comprise oxygenated compounds selected from the group consisting of ketones, aldehydes, carboxylic acids, alcohols, ethers, esters, and combinations thereof.

3. The method of claim 1 wherein said wastewater comprises at least about 4 wt % water-soluble organics and said treated water comprises less than about 80 wt % of said water-soluble organics contained in said wastewater.

4. The method of claim 3 wherein said wastewater comprises at least about 5 wt % water-soluble organics and said treated water comprises less than about 75 wt % of said water-soluble organics contained in said wastewater.

5. The method of claim 1 wherein said tar contains at least about 25 wt % of phenol-derived compounds.

6. The method of claim 5 wherein said tar contains at least about 40 wt % of phenol-derived compounds.

7. The method of claim 1 wherein at least 20% of said phenols contained in said wastewater become a part of said tar.

8. The method of claim 7 wherein at least 30% of said phenols contained in said wastewater become a part of said tar.

9. The method of claim 1 wherein, prior to the addition of said acid, said wastewater has a pH value in the range of about 2 to about 3.

10. The method of claim 1 wherein said acid is added to said wastewater in an amount such that the concentration of said acid in said wastewater is at least about 300 ppmw, based on the total weight of said wastewater.

11. The method of claim 10 wherein said acid is added to said wastewater in an amount such that the concentration of said acid in said wastewater is at least about 500 ppmw, based on the total weight of said wastewater.

12. The method of claim 10 wherein said acid is added to said wastewater in an amount such that the concentration of said acid in said wastewater is at least about 1000 ppmw and no more than about 2 wt %, based on the total weight of said wastewater.

13. The method of claim 1 wherein said acid is selected from the group consisting of sulfuric acid, hydrochloric acid, hydrobromic acid, phosphoric acid, and combinations thereof.

14. The method of claim 13 wherein said acid is sulfuric acid.

15. The method of claim 1 wherein, after the addition of said acid in step a), said wastewater is at a temperature of at least about 50° C.

16. The method of claim 15 wherein, after the addition of said acid in step a), said wastewater is at a temperature of at least about 60° C. and less than about 200° C.

17. The method of claim 1 wherein the wt % of said tar after no more than about 1 day following the addition of said acid in step a), and based on the combined weight of said treated water and said tar, is greater than about 2 wt %.

18. The method of claim 1 wherein the wt % of said tar after no more than about 4 days following the addition of said acid in step a), and based on the combined weight of said treated water and said tar, is greater than about 3 wt %.

19. The method of claim 1 wherein the wt % of said tar after no more than about 20 days following the addition of said acid in step a), and based on the combined weight of said treated water and said tar, is greater than about 4 wt %.
